(19) United States
(12) Patent Application Publication
(10) Pub. No.: US 2026/0109388 A1
(43) Pub. Date: Apr. 23, 2026

(54) STEERING WHEEL POWER ASSIST DEVICE

(71) Applicant: Shenzhen Glamortech Industrial Co., Ltd, Shenzhen (CN)

(72) Inventor: PENGBO MU, Huizhou (CN)

(21) Appl. No.: 19/428,206

(22) Filed: Dec. 21, 2025

(30) Foreign Application Priority Data
Jun. 17, 2025 (CN) 202510810915.7

(51) Int. Cl. B62D 1/04

(52) U.S. Cl. CPC B62D 1/043

(57) ABSTRACT

A steering wheel power assist device is provided. The device includes a hand-held component and a fixed component. The fixed component includes a fixed bracket, a fixed base, and a fastening nut. The fixed base is arranged between the fixed bracket and the fastening nut. The fixed bracket includes a connecting part and a bracket body arranged in a U shape. The connecting part is arranged at one end that is of a support leg and that is far away from the bracket body. A tail end of the support leg of the bracket body is provided with an external thread. The fastening nut is sleeved on the support leg of the bracket body. The fixed bracket and the bracket body form an accommodation space.

### TECHNICAL FIELD

The present disclosure relates to the technical field of vehicles, and in particular, to a steering wheel power assist device.

### BACKGROUND

A steering wheel power assist device is a device mounted on a steering wheel of a vehicle to assist a driver to control the steering wheel, which can reduce hand fatigue of the driver during steering and improve driving comfort and safety. With the increase in vehicle ownership and the growing demand for driving comfort, the steering wheel power assist device has been widely used.

A steering wheel power assist device in the prior art has the following problems: first, the mounting operation of a conventional steering wheel power assist device is cumbersome, a tool is usually needed to complete mounting, and it is difficult to adapt to the thickness difference of different steering wheels, which affects a user experience; second, a power assist device with an integrated clamping structure lacks an effective adjustment function, and when the steering wheel is too thick or too thin, problems such as loosening or failure to clamp easily occur, which affects driving safety; and finally, the anti-slip design of the existing products is insufficient, which may cause the power assist device to slide on the steering wheel after long-term use, and may reduce control stability. Therefore, there is an urgent need for a steering wheel power assist device which is simple to mount, strong in adaptability and good in anti-slip performance.

### SUMMARY

In view of this, aiming at the defects of the prior art, an embodiment of the present disclosure provides a steering wheel power assist device, which is capable of being quickly mounted and compatible with different steering wheel thicknesses, and enhances anti-slip and anti-loosening performance.

In order to achieve the above objective, the technical solution used by the present disclosure is as follows.

A steering wheel power assist device is provided, including a hand-held component and a fixed component, where the fixed component includes a fixed bracket, a fixed base, and a fastening nut, and the fixed base is arranged between the fixed bracket and the fastening nut; and the fixed bracket includes a connecting part and a bracket body arranged in a U shape, the connecting part is arranged at one end that is of a support leg and that is far away from the bracket body, a tail end of the support leg of the bracket body is provided with an external thread, the fastening nut is sleeved on the support leg of the bracket body, and the fixed base and the bracket body form an accommodation space. Through threaded rotation of the fastening nut on the bracket body, the accommodation space can be adjusted to adapt to steering wheels of different sizes.

Preferably, the hand-held component includes a hand-held upper cover, a hand-held lower cover, and a rotating bearing arranged between the hand-held upper cover and the hand-held lower cover.

Further, the hand-held lower cover includes a bearing embedding groove, and the rotating bearing is in interference connection with the bearing embedding groove.

Still further, the hand-held lower cover further includes a central opening, and the connecting part is fixedly connected with the rotating bearing through the central opening.

Preferably, the fixed base is provided with a U-shaped groove to avoid the support leg of the bracket body.

Preferably, the fixed base is provided with a first outwardly extending edge, and a diameter of the first outwardly extending edge is greater than an inner diameter of the fastening nut.

Preferably, a surface that is of the fixed base and that faces the fixed bracket is arranged in a C shape.

Preferably, the fixed component further includes a first flexible member, the first flexible member is arranged on a surface that is of the fixed bracket and that faces the fixed base, and a first surface of the first flexible member is provided with a first anti-slip rib.

Preferably, the fixed component further includes a second flexible member, the second flexible member is arranged on the surface that is of the fixed base and that faces the fixed bracket, and a second surface of the second flexible member is provided with a second anti-slip rib.

Preferably, the fixed component further includes a base lower cover, the base lower cover is fixedly connected with the fixed base, the base lower cover is provided with a second outwardly extending edge, and a diameter of the second outwardly extending edge is greater than the inner diameter of the fastening nut.

Preferably, an outer edge of the fastening nut is provided with an anti-slip lug.

The present disclosure has the following beneficial effect. Through the U-shaped design of the fixed bracket and the thread adjustment function of the fastening nut, a user may adjust the size of the accommodation space according to thicknesses of different steering wheels, thereby achieving rapid mounting without any tools, and solving the problem that the mounting operation of a conventional steering wheel power assist device is cumbersome. The design of anti-slip ribs on the first flexible member and the second flexible member enhances a friction force between the device and the steering wheel, effectively prevents the power assist device from sliding during use, and improves control stability. The design of an anti-slip lug on the outer edge of the fastening nut is convenient for a user to adjust the fastening strength by hand, which ensures that the device is firmly mounted on the steering wheel and avoids the problem of looseness. At the same time, the design of the outwardly extending edges of the fixed base and the base lower cover may ensure that the fixed base and the base lower cover move synchronously with the fastening nut.

### BRIEF DESCRIPTION OF THE DRAWINGS

In order to explain the technical solution of the embodiment of the present disclosure more clearly, the accompanying drawings that need to be used in the embodiment will be briefly introduced hereinafter. It should be understood that the following accompanying drawings only show some embodiments of the present disclosure, and therefore, should not be regarded as a limitation of the scope. For those skilled in the art, other related accompanying drawings may be obtained according to these accompanying drawings without paying creative labor.

FIG. 1 shows an exploded view of a steering wheel power assist device according to an embodiment of the present disclosure;

FIG. 2 shows a schematic diagram of an overall structure of a steering wheel power assist device according to an embodiment of the present disclosure;

FIG. 3 shows a schematic diagram of a use state of a steering wheel power assist device according to an embodiment of the present disclosure;

FIG. 4 shows a schematic diagram of a structure of a hand-held upper cover according to an embodiment of the present disclosure;

FIG. 5 shows a schematic diagram of a structure of a hand-held lower cover according to an embodiment of the present disclosure;

FIG. 6 shows a schematic diagram of a structure of a bracket body according to an embodiment of the present disclosure;

FIG. 7 shows a schematic diagram of a structure of a rotating bearing according to an embodiment of the present disclosure;

FIG. 8 shows a top view of a structure of a fixed base according to an embodiment of the present disclosure;

FIG. 9 shows a bottom view of a structure of a fixed base according to an embodiment of the present disclosure;

FIG. 10 shows a schematic diagram of a structure of a fastening nut according to an embodiment of the present disclosure;

FIG. 11 shows a schematic diagram of a structure of a base lower cover according to an embodiment of the present disclosure;

FIG. 12 shows a schematic diagram of a structure of a first flexible member according to an embodiment of the present disclosure; and

FIG. 13 shows a schematic diagram of a structure of a second flexible member according to an embodiment of the present disclosure.

Reference numerals in the figure are as follows:

1, hand-held upper cover; 101, first sealing lip;

2, hand-held lower cover; 201, second sealing lip; 202, bearing embedding groove; 203, central opening;

3, fixed bracket; 301, first support leg; 302, a second support leg; 303, first external thread; 304, second external thread; 305, connecting part; 306, bracket body; 307, inner surface of the bracket body;

4, rotating bearing; 401, bearing outer ring; 402, bearing inner ring;

5, fixed base; 501, mounting groove; 502, U-shaped groove; 503, first outwardly extending edge;

6, fastening nut; 601, anti-slip lug;

7, base lower cover; 701, second outwardly extending edge;

8, first flexible member; 801, first mounting surface; 802, first anti-slip rib;

9, second flexible member; 901, positioning column; 902, second anti-slip rib;

10, steering wheel

### DETAILED DESCRIPTION OF THE EMBODIMENTS

In order to make the objective, the technical solution and the advantages of the embodiment of the present disclosure clearer, the technical solution in the embodiment of the present disclosure will be described clearly and completely with reference to the accompanying drawings. Obviously, the described embodiments are some embodiments of the present disclosure, rather than all of the embodiments.

Based on this, some embodiments of the present disclosure will be described in detail with reference to the accompanying drawings. In the case of no conflict, the following embodiments and features in the embodiments can be combined with each other.

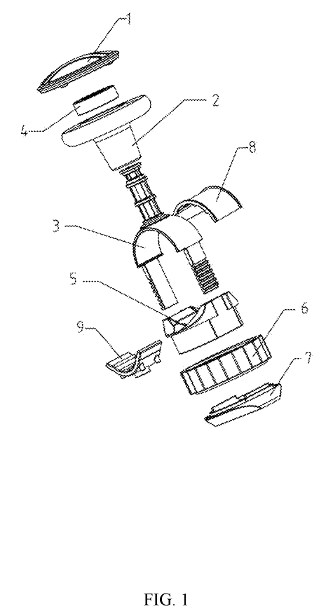

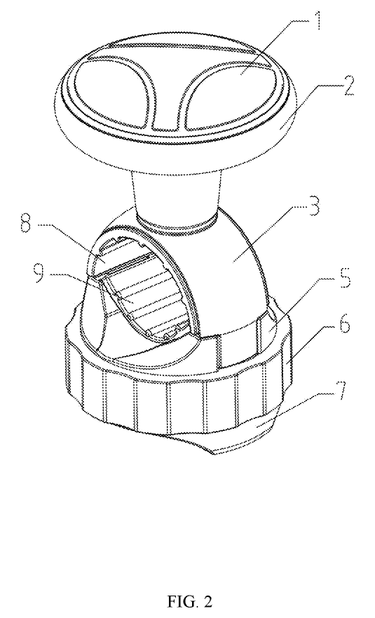

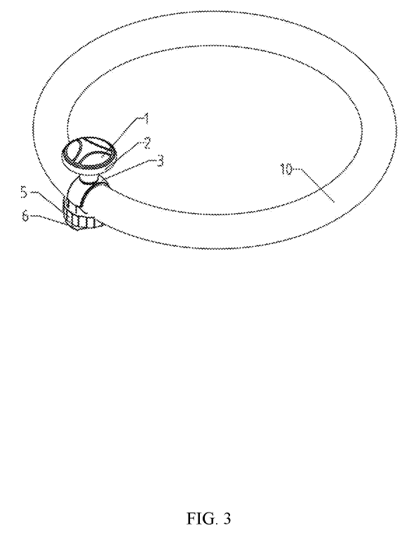

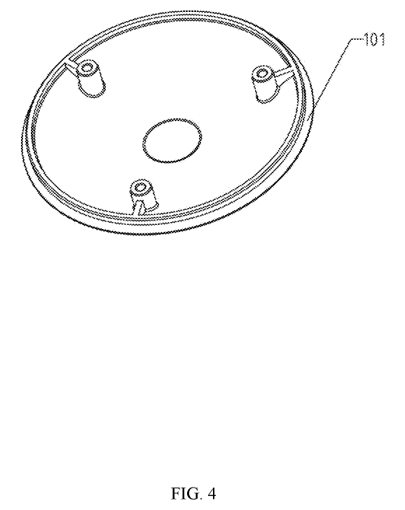

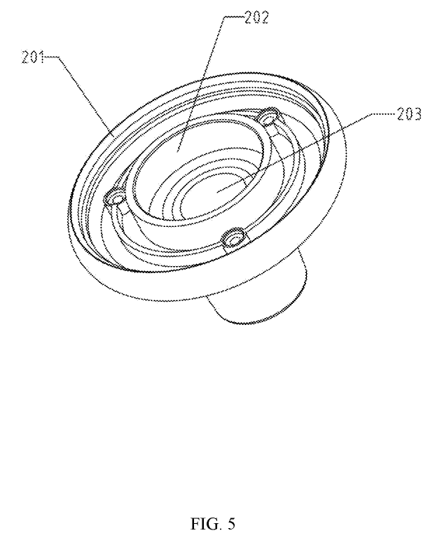

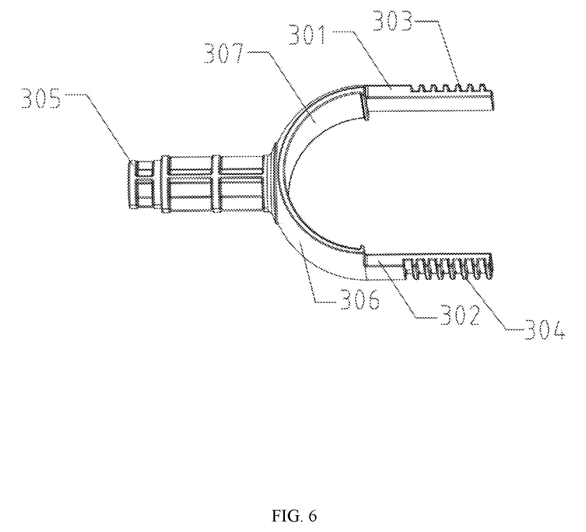

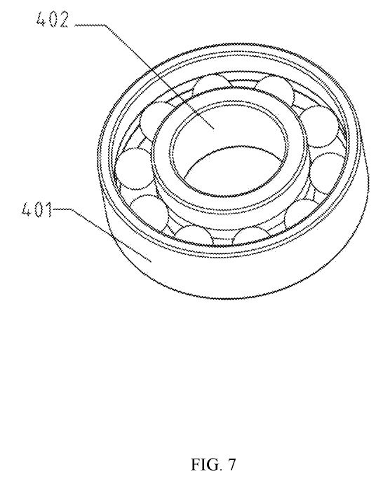

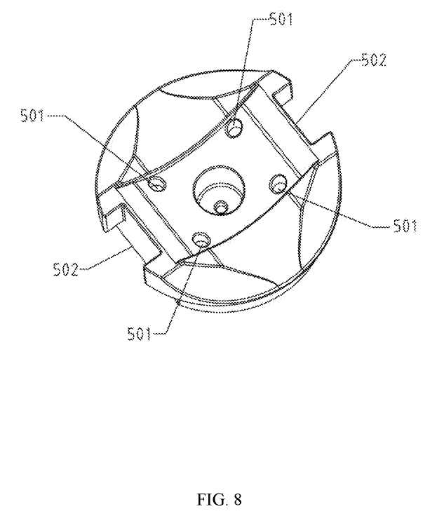

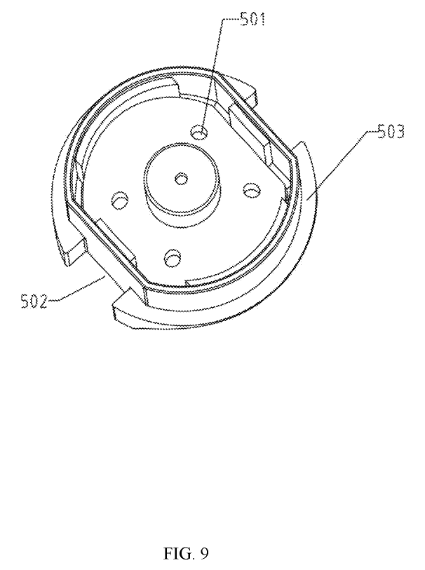

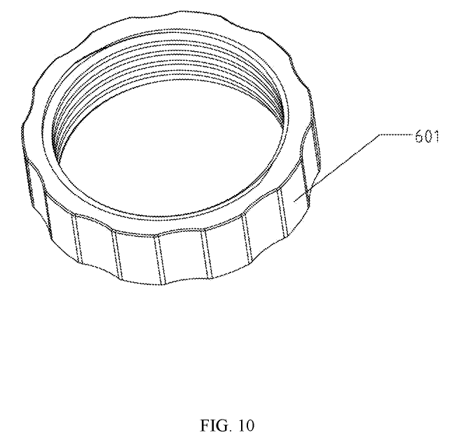

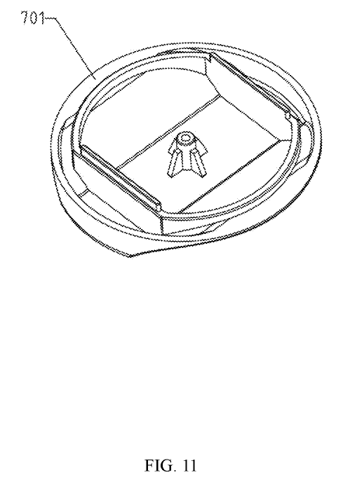

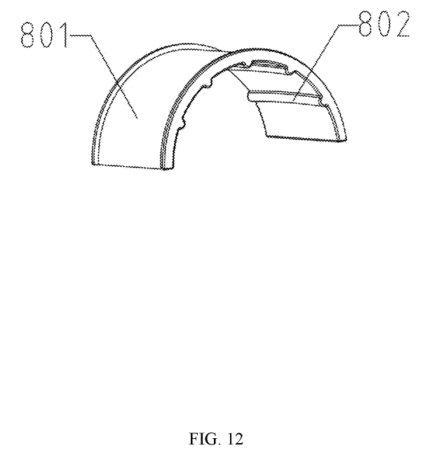

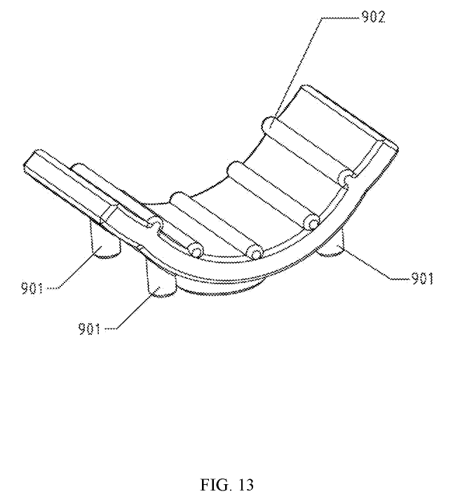

Refer to FIG. 1 to FIG. 13. An embodiment of the present disclosure provides a steering wheel power assist device, including a hand-held component and a fixed component. The fixed component includes a fixed bracket 3, a fixed base 5, and a fastening nut 6. The fixed base 5 is arranged between the fixed bracket 3 and the fastening nut 6. The fixed bracket 3 includes a connecting part 305 and a bracket body 306 arranged in a U shape. The connecting part 305 is arranged at one end that is of a support leg and that is far away from the bracket body 306. A tail end of a first support leg 301 of the bracket body 306 is provided with a first external thread 303. The fastening nut 6 is sleeved on two support legs 301 and 302 of the bracket body. A center distance between the first support leg 301 and the second support leg 302 may be 35 mm to 40 mm. The fixed base 5 and the bracket body 306 form an accommodation space. The position of the fastening nut 6 on the first external thread 303 can be adjusted by rotation, and the size of the accommodation space can be adjusted to adapt to steering wheels of different sizes.

Further, a tail end of the second support leg 302 of the bracket body 305 is provided with a second external thread 304.

In some optional embodiments, the hand-held component includes a hand-held upper cover 1, a hand-held lower cover 2, and a rotating bearing 4 arranged between the hand-held upper cover 1 and the hand-held lower cover 2. The hand-held lower cover 2 includes a bearing embedding groove 202, and the rotating bearing 4 is in interference connection with the bearing embedding groove 202. Specifically, a bearing outer ring 401 of the rotating bearing 4 is in interference connection with the bearing embedding groove 202. The hand-held lower cover 2 further includes a central opening 203, and the connecting part 305 is fixedly connected with the rotating bearing 4 through the central opening 203. Specifically, the connecting part 305 is fixedly connected with a bearing inner ring 402 of the rotating bearing 4 through the central opening 203.

In some optional embodiments, the fixed base 5 is provided with a U-shaped groove 502 to avoid the support leg of the bracket body. The width of the U-shaped groove may be 15 mm.

In some optional embodiments, the fixed base 5 is provided with a first outwardly extending edge 503, and a diameter of the first outwardly extending edge 503 is greater than an inner diameter of the fastening nut 6, so as to ensure that the fixed base 5 moves together with the fastening nut 6 when the fastening nut 6 rotates, thereby achieving the effect of adjusting the size of the accommodation space.

In some optional embodiments, a surface that is of the fixed base 5 and that faces the fixed bracket is arranged in a C shape. Because the steering wheel is usually cylindrical, when the steering wheel power assist device is fixed to the steering wheel, the C-shaped surface may fit with a contact surface of the steering wheel better, increase a contact area, and become more stable.

In some optional embodiments, the fixed component further includes a first flexible member 8. The first flexible member 8 is arranged a surface that is of the fixed bracket 3 and that faces the fixed base 5. A first surface of the first flexible member 8 is provided with a first anti-slip rib 802, which can increase a friction force and achieve a better anti-slip effect.

Optionally, the first flexible member 8 can be fixedly connected with the inner surface 307 of the bracket body by adhesive bonding on the first mounting surface 801, and the inner surface 307 of the bracket body may be a semi-circular cylindrical surface of R18.

In some optional embodiments, the fixed component further includes a second flexible member 9. The second flexible member 9 is arranged on the surface that is of the fixed base 5 and that faces the fixed bracket 3. A second surface of the second flexible member 9 is provided with a second anti-slip rib 902, which can increase a friction force and achieve a better anti-slip effect.

Optionally, the second flexible member 9 includes a plurality of positioning columns 901. The fixed base 5 is provided with a plurality of mounting grooves 501. The second flexible member 901 can be fixedly connected with the fixed base 5 in such a manner that the positioning columns 901 are engaged with the mounting grooves 501.

In some optional embodiments, the fixed component further includes a base lower cover 7. The base lower cover 7 is fixedly connected with the fixed base 5. The base lower cover 7 is provided with a second outwardly extending edge 701. A diameter of the second outwardly extending edge 701 is greater than the inner diameter of the fastening nut 6, so as to ensure that both the base lower cover 7 and the fixed base 5 move together with the fastening nut 6 when the fastening nut 6 rotates, thereby achieving the effect of adjusting the size of the accommodation space.

In some optional embodiments, an outer edge of the fastening nut 6 is provided with an anti-slip lug 601, which can prevent slipping when the fastening nut 6 rotates.

The specific structure of the steering wheel power assist device of the embodiment of the present disclosure is as follows.

The steering wheel power assist device mainly consists of two parts: a hand-held component and a fixed component. The hand-held component is a part that is in direct contact with a user, while the fixed component is responsible for firmly mounting the whole device on the steering wheel.

The structural design of the hand-held component is as follows.

The hand-held component includes a hand-held upper cover 1, a hand-held lower cover 2, and a rotating bearing 4. The hand-held upper cover 1 and the hand-held lower cover 4 are connected by buckles or screws to form an integral hand-held part, which is arranged in a spherical shape and provides a user with a comfortable holding experience. The hand-held upper cover 1 includes a first sealing lip 101, and the hand-held lower cover 2 includes a second sealing lip 201. Heights of both the first sealing lip 101 and the second sealing lip 201 may be 1.5 mm. The first sealing lip and the second sealing lip cooperate with each other to form a sealing structure, which can effectively prevent dust and sweat from entering the hand-held component, and prolong a service life. The hand-held upper cover 1 is ergonomically designed, and may be made of high-strength Acrylonitrile-Butadiene-Styrene (ABS) engineering plastic by injection molding. The surface of the hand-held upper cover is provided with an anti-slip texture (not shown in the figure), and the depth of the texture may be 0.4 mm to 1 mm, so as to ensure that a user can firmly hold the hand-held upper cover during driving. A rotating bearing 4 is arranged between the hand-held upper cover 1 and the hand-held lower cover 2. The rotating bearing allows the hand-held part to rotate freely with respect to the fixed component fixed on the steering wheel.

The structure of the hand-held lower cover 2 includes a bearing embedding groove 202. The size of the groove matches the bearing outer ring 401 of the rotating bearing 4, and interference connection is used to ensure that the rotating bearing 4 may not loosen or fall off during use. The interference connection indicates that the outer diameter of the bearing is slightly greater than the inner diameter of the bearing embedding groove. A specific pressure needs to be applied during mounting. For example, a hydraulic machine is used with a pressure of 500kgf. A close fit is formed between the rotating bearing 4 and the bearing embedding groove 202 after mounting.

A central opening 203 is arranged at the central position of the hand-held lower cover 2, through which the connecting part 305 of the fixed bracket 3 is allowed to pass. In addition, the connecting part is fixedly connected with the bearing inner ring 402 of the rotating bearing 4. This design allows the hand-held component to freely rotate around the connecting part 305 of the fixed bracket 3 while maintaining the structural stability. The fixed connection between the connecting part 305 and the rotating bearing 4 may be achieved by interference fit or threaded connection, so as to ensure firm and reliable connection.

The structural design of the fixed component is as follows.

The core part of the fixed component is the fixed bracket 3, which includes two main parts: the connecting part 305 and the bracket body 306. The connecting part 305 is a part connected with the hand-held component, and is arranged at one end of a support leg far away from the bracket body 306. The bracket body 306 has a U-shaped design, so that the bracket body can be sleeved on an annular structure of the steering wheel. A tail end of the support leg of the bracket body 306 is provided with an external thread for cooperating with the fastening nut to form an adjustable clamping mechanism.

The fastening nut 6 is sleeved on the support leg of the bracket body 306. By rotating the fastening nut 6, the size of the accommodation space formed between the bracket body 306 and the fastening nut 6 may be adjusted, so as to adapt to steering wheels with different thicknesses. An outer edge of the fastening nut 6 is provided with a plurality of anti-slip lugs 601. The lugs increase the contact area between a finger of a user and the fastening nut 6, and improve convenience and comfort of the rotating operation. The number of anti-slip lugs 601 is generally 4 to 8. The anti-slip lugs are evenly distributed on the outer edge of the fastening nut 6. Each lug has a height of about 1 mm to 2 mm and a width of about 4 mm to 8 mm. The surface of each lug is provided with an anti-slip texture (not shown in the figure).

The fixed component further includes a fixed base 5, which is arranged between the fixed bracket 3 and the fastening nut 6. The fixed base 5 is provided with a U-shaped groove 502. The U-shaped groove 502 is used to avoid the first support leg 301 and the second support leg 302 of the bracket body, so that the fixed base 5 can smoothly fit with the surface of the steering wheel. The fixed base 5 is provided with a first outwardly extending edge 503. A diameter of the edge is greater than an inner diameter of the fastening nut. This design ensures that the fixed base 5 moves together with the fastening nut 6 when the fastening nut 6 rotates, thereby achieving the effect of adjusting the size of the accommodation space. The diameter of the first outwardly extending edge 503 is generally the same as the outer diameter of the fastening nut 6.

The surface that is of the fixed base 5 and that faces the fixed bracket 3 is arranged in a C shape. This design causes the surface to fit with a curved surface of the steering wheel better, increasing the contact area, and improving the mounting stability. The curvature radius of the C-shaped design usually matches the curvature radius of the standard steering wheel to ensure an optimal fitting effect.

In order to further improve mounting stability and protect the surface of the steering wheel, the fixed component further includes a first flexible member 8 and a second flexible member 9. The first flexible member 8 is arranged on a surface that is of the fixed bracket 3 and that faces the fixed base 5, and a first surface of the first flexible member 8 is provided with a first anti-slip rib 802. The second flexible member 9 is arranged on the surface that is of the fixed base 5 and that faces the fixed bracket 3, and a second surface of the second flexible member 9 is provided with a second anti-slip rib 902. These two flexible members are usually made of rubber, silica gel or soft plastic materials, and have a thickness of about 2±0.2 mm. In addition, edges of the flexible members are both provided with thick wrapping structures. The thickness may be 0.5 mm, and the compression permanent deformation rate is ≤15% (GB/T7759), which can adapt to slight unevenness of the surface of the steering wheel and provide a better fitting effect.

The first anti-slip rib 802 and the second anti-slip rib 902 are convex structures arranged in parallel, in which the height is about 0.5 mm to 1.5 mm, the width is about 1 mm to 2 mm, and the spacing is about 5 mm to 10 mm. These ribs increase the friction force, and prevent the device from sliding or shifting during use. The arrangement direction of the ribs is usually perpendicular to the radial direction of the steering wheel to provide a maximum anti-slip effect.

The fixed component further includes a base lower cover 7, which is located below the fastening nut 6 and plays a role in protecting the steering wheel and increasing stability. The base lower cover 7 is provided with a second outwardly extending edge 701, and a diameter of the second outwardly extending edge 701 is greater than the inner diameter of the fastening nut 6. This design is similar to the first outwardly extending edge 503 of the fixed base 5. When the fixed base 5 is fixedly connected with the base lower cover 7, it is ensured that both the base lower cover 7 and the fixed base 5 move together with the fastening nut 6 when the fastening nut 6 rotates, thereby achieving the effect of adjusting the size of the accommodation space. The diameter of the second outwardly extending edge is usually close to that of the first outwardly extending edge, forming symmetrical clamping structures.

The working principle of the steering wheel power assist device of this embodiment is as follows.

During mounting, a user first sleeves the U-shaped bracket body 306 of the fixed bracket 3 on the steering wheel, preferably at the 2 o'clock or 10 o'clock direction of the steering wheel. Adjustment is performed until the first flexible member 8 completely fits with the contact surface of the steering wheel. Then, the fixed base 5 is placed on the support leg of the bracket body 306, so that the U-shaped groove 502 is aligned with the first support leg 301 and the second support leg 302 of the bracket body, respectively. Next, the fastening nut 6 rotates to move along the first external thread 303 and the second external thread 304 of the support leg of the bracket body until a distance between the fastening nut 6 and the fixed base 5 is suitable for clamping the steering wheel. Finally, the fastening nut 6 can be further tightened, and the final torque is controlled within the range of 15 N·m to 20 N·m to ensure that the whole device is firmly fixed to the steering wheel.

During use, a user may hold the hand-held component, and use an extra fulcrum provided by the hand-held component to assist in rotating the steering wheel, thus reducing arm fatigue. Because the hand-held component and the fixed component are connected through the rotating bearing 4, the hand-held component may rotate freely when held by a user without hindering the normal rotation of the steering wheel.

When a user needs to adjust the position of the device or disassemble the device, the user only needs to rotate the fastening nut 6 reversely and loosen the clamping force to easily move or remove the whole device.

The steering wheel power assist device of this embodiment has the following advantages.

1. The steering wheel power assist device is simple in structure and convenient to mount and remove without a professional tool.

2. The steering wheel power assist device can adapt to steering wheels with different thicknesses and shapes by adjusting the fastening nut.

3. The design of the flexible member and the anti-slip rib increases stability of the device and prevents sliding during use.

4. The design of the rotating bearing between the hand-held component and the fixed component ensures the flexible operation of the steering wheel.

5. The design of the anti-slip lug allows the rotation operation of the fastening nut to be more convenient.

6. The overall structure is compact without occupying too much space or affecting the driving sight.

Finally, it should be explained that the foregoing embodiments are only specific implementations of the present disclosure, which are used to illustrate the technical solution of the present disclosure, rather than limit the technical solution. The scope of protection of the present disclosure is not limited thereto. Although the present disclosure has been described in detail with reference to the foregoing embodiments, it should be understood by those skilled in the art that within the technical scope disclosed in present disclosure, modifications can still be made to the technical solution described in the foregoing embodiments, changes can be easily conceived, or equivalent substitutions can be made to some of the technical features therein. However, such modifications, changes, or replacements do not cause the essence of the corresponding technical solution to deviate from the spirit and scope of the technical solution of the embodiments of the present disclosure. All such modifications, changes, or replacements shall be covered within the scope of protection of the present disclosure. Therefore, the scope of protection of the present disclosure shall be subject to the scope of protection defined by the appended claims.

What is claimed is:

1. A steering wheel power assist device, comprising a hand-held component and a fixed component, wherein
the fixed component comprises a fixed bracket, a fixed base, and a fastening nut, and the fixed base is arranged between the fixed bracket and the fastening nut; and
the fixed bracket comprises a connecting part and a bracket body arranged in a U shape, the connecting part is arranged at one end that is of a support leg and that is far away from the bracket body, a tail end of the support leg of the bracket body is provided with an external thread, the fastening nut is sleeved on the support leg of the bracket body, and the fixed base and the bracket body form an accommodation space.

2. The steering wheel power assist device according to claim 1, wherein the hand-held component comprises a hand-held upper cover, a hand-held lower cover, and a rotating bearing arranged between the hand-held upper cover and the hand-held lower cover.

3. The steering wheel power assist device according to claim 2, wherein the hand-held lower cover comprises a bearing embedding groove, and the rotating bearing is in interference connection with the bearing embedding groove.

4. The steering wheel power assist device according to claim 3, wherein the hand-held lower cover further comprises a central opening, and the connecting part is fixedly connected with the rotating bearing through the central opening.

5. The steering wheel power assist device according to claim 1, wherein the fixed base is provided with a U-shaped groove to avoid the support leg of the bracket body.

6. The steering wheel power assist device according to claim 1, wherein the fixed base is provided with a first outwardly extending edge, and a diameter of the first outwardly extending edge is greater than an inner diameter of the fastening nut.

7. The steering wheel power assist device according to claim 1, wherein a surface that is of the fixed base and that faces the fixed bracket is arranged in a C shape.

8. The steering wheel power assist device according to claim 1, wherein the fixed component further comprises a first flexible member, the first flexible member is arranged on a surface that is of the fixed bracket and that faces the fixed base, and a first surface of the first flexible member is provided with a first anti-slip rib.

9. The steering wheel power assist device according to claim 1, wherein the fixed component further comprises a second flexible member, the second flexible member is arranged on the surface that is of the fixed base and that faces the fixed bracket, and a second surface of the second flexible member is provided with a second anti-slip rib.

10. The steering wheel power assist device according to claim 1, wherein the fixed component further comprises a base lower cover, the base lower cover is fixedly connected with the fixed base, the base lower cover is provided with a second outwardly extending edge, and a diameter of the second outwardly extending edge is greater than the inner diameter of the fastening nut.

11. The steering wheel power assist device according to claim 1, wherein an outer edge of the fastening nut is provided with an anti-slip lug.
